(19) United States
(12) Patent Application Publication
(10) Pub. No.: US 2025/0253318 A1
(43) Pub. Date: Aug. 7, 2025

(54) CATHODE ACTIVE MATERIAL FOR A LITHIUM SECONDARY BATTERY WITH NOVEL COMPOSITION

(71) Applicants: Hyundai Motor Company, Seoul (KR); Kia Corporation, Seoul (KR)

(72) Inventors: Byeong Sun Jun, Seoul (KR); Sang Heon Lee, Seoul (KR); Kwang Jin Kim, Seoul (KR); Hong Seok Min, Seoul (KR); Dae Yeon Hwang, Seoul (KR)

(21) Appl. No.: 18/819,318

(22) Filed: Aug. 29, 2024

(30) Foreign Application Priority Data
Feb. 5, 2024 (KR) 10-2024-0017120

(51) Int. Cl. H01M 4/36; H01M 4/02; H01M 4/505; H01M 4/525; H01M 4/62; H01M 10/052; H01M 10/0562

(52) U.S. Cl. CPC H01M 4/366; H01M 4/505; H01M 4/525; H01M 4/625; H01M 10/052; H01M 10/0562; H01M 2004/021; H01M 2004/028; H01M 2300/0068

(57) ABSTRACT

Provided is a cathode active material for lithium secondary batteries, featuring a core component with a coating part comprising lithium oxide. The lithium oxide includes lithium, a first element, and a second element substituting part of the first element. The first element can be boron (B), aluminum (Al), gallium (Ga), niobium (Nb), protactinium (Pa), or tantalum (Ta). The cathode active material demonstrates improved electrochemical stability and interfacial properties, with specified reduction and oxidation potentials. The lithium secondary battery comprises this cathode, an anode, and a solid electrolyte layer interposed between them. The core component may consist of lithium transition metal oxide in the form of secondary particles aggregating primary particles, providing enhanced performance. The solid electrolyte may be sulfide-based with an argyrodite crystal structure. The battery also includes a conductive material and a binder for improved functionality and stability.

### CROSS-REFERENCE TO RELATED APPLICATION

This application claims, under 35 U.S.C. § 119 (a), the benefit of Korean Patent Application No. 10-2024-0017120, filed on Feb. 5, 2024, the entire contents of which are incorporated herein by reference.

### BACKGROUND

### Technical Field

The present disclosure relates to the field of lithium secondary batteries, specifically to the development and application of cathode active materials. It focuses on the design and composition of cathode materials with enhanced electrochemical stability and interfacial properties, involving lithium oxide coatings with substituted elements. The disclosure further encompasses the structural configurations of these cathode materials and their integration into lithium secondary batteries, including the use of solid electrolytes and various conductive materials to optimize battery performance.

### Background

Rechargeable secondary batteries are used not only in small electronic devices such as mobile phones, laptops, etc., but also in large vehicles such as hybrid vehicles, electric vehicles, etc. Accordingly, there is a need to develop secondary batteries having higher stability and energy density.

Most existing secondary batteries have cells based on organic liquid electrolytes, so limitations are imposed on improving stability and energy density thereof.

Meanwhile, all-solid-state batteries using inorganic solid electrolytes are receiving great attention recently because they are based on technology that excludes organic solvents and cells are manufactured in a safe and simple form.

However, all-solid-state batteries have problems such as high interfacial resistance and side reaction at the interface between the cathode active material and the solid electrolyte. In order to solve such problems, a coating layer is generally applied to the cathode active material. The coating layer must have excellent interfacial stability with the cathode active material and the solid electrolyte, and electrochemical stability of the material alone must be high.

### SUMMARY OF THE DISCLOSURE

An object of the present disclosure is to provide a cathode active material for a lithium secondary battery with excellent electrochemical stability.

Another object of the present disclosure is to provide a cathode active material for a lithium secondary battery with excellent interfacial stability with a solid electrolyte.

The objects of the present disclosure are not limited to the foregoing. The objects of the present disclosure will be able to be clearly understood through the following description and to be realized by the means described in the claims and combinations thereof.

In some embodiments, a cathode active material for a lithium secondary battery comprises a core component and a coating part applied onto a surface of the core component, wherein the coating part comprises lithium oxide, and the lithium oxide comprises lithium, a first element, and a second element that substitutes for at least a part of the first element.

The first element forming an oxide with the lithium may satisfy the condition that the reduction potential of the oxide is 2.5 V or less but greater than 0 V and the oxidation potential of the oxide is 3.8 V to 5.5 V, or the electrochemical stability window (ESW) of the oxide is 2.5 V to 5.5 V. The first element may comprise boron (B), aluminum (Al), gallium (Ga), niobium (Nb), protactinium (Pa), or tantalum (Ta). The oxidation number or coordination number of the second element may be equal to the oxidation number or coordination number of the first element. The second element may be different from the first element and may comprise aluminum (Al), boron (B), tantalum (Ta), or niobium (Nb). The lithium oxide may have interfacial reaction energy of −0.05 eV or less for LiNi_{0.8}Co_{0.1}Mn_{0.1}O₂ and −0.2 eV or less for Li₆PS₅Cl. The lithium oxide may include at least one selected from among Chemical Formula 1 to Chemical Formula 11 below.

Li₃B₇₋ₓ₁Alₓ₁O₁₂ [Chemical Formula 1]

Chemical Formula 1 may satisfy 0.2857≤x1≤0.8571.

LiAl₅₋ₓ₂Bₓ₂O₈ [Chemical Formula 2]

Chemical Formula 2 may satisfy 0.85≤x2≤0.95.

Li₃B₃₋ₓ₃Alₓ₃O₅ [Chemical Formula 3]

Chemical Formula 3 may satisfy 0.33333x3≤0.8333.

LiGa₅₋ₓ₄Alₓ₄O₈ [Chemical Formula 4]

In Chemical Formula 4, x4 may be 0.6.

LiAl₅₋ₓ₅Bₓ₅O₈ [Chemical Formula 5]

Chemical Formula 5 may satisfy 0.85≤x5≤0.95.

LiNb₁₃₋ₓ₆Taₓ₆O₃₃ [Chemical Formula 6]

Chemical Formula 6 may satisfy 0.1538≤x6≤0.8462.

LiNb₃₋ₓ₇Taₓ₇O₈ [Chemical Formula 7]

Chemical Formula 7 may satisfy 0.33333x7<0.8333.

LiPa₁₋ₓ₈Nbₓ₈O₃ [Chemical Formula 8]

In Chemical Formula 8, x8 may be 0.25.

LiPa₁₋ₓ₉Taₓ₉O₃ [Chemical Formula 9]

In Chemical Formula 9, x9 may be 0.25.

Li₃Ta₇₋ₓ₁₀Nbₓ₁₀O₁₉ [Chemical Formula 10]

In Chemical Formula 10, x10 may be 0.8571.

LiTa₃₋ₓ₁₁Nbₓ₁₁O₈ [Chemical Formula 11]

Chemical Formula 11 may satisfy 0.1667≤x11≤0.8333.

In some embodiments, a cathode for a lithium secondary battery comprises the aforementioned cathode active material and a solid electrolyte.

In some embodiments, a lithium secondary battery comprises a cathode comprising a cathode active material including a core component and a coating part applied onto the surface of the core component, wherein the coating part comprises lithium oxide, and the lithium oxide comprises lithium, a first element, and a second element that substitutes for at least a part of the first element; an anode; and a solid electrolyte layer interposed between the cathode and the anode.

The first element in the lithium oxide may comprise boron (B), aluminum (Al), gallium (Ga), niobium (Nb), protactinium (Pa), or tantalum (Ta). The second element in the lithium oxide may comprise aluminum (Al), boron (B), tantalum (Ta), or niobium (Nb). The solid electrolyte layer may comprise a sulfide-based solid electrolyte having an argyrodite crystal structure. The cathode may further comprise a conductive material selected from the group consisting of carbon black, conductive graphite, ethylene black, graphene, carbon nanotubes, carbon nanofiber, and vapor grown carbon fiber. The lithium oxide in the coating part may have interfacial reaction energy of −0.05 eV or less for LiNi_{0.8}Co_{0.1}Mn_{0.1}O₂ and −0.2 eV or less for Li₆PS₅Cl.

In some embodiments, a lithium secondary battery comprises a cathode comprising a cathode active material including a core component and a coating part applied onto the surface of the core component, wherein the coating part comprises lithium oxide, and the lithium oxide comprises lithium, a first element, and a second element that substitutes for at least a part of the first element; an anode; and a solid electrolyte layer interposed between the cathode and the anode, wherein the core component comprises lithium transition metal oxide.

The core component may comprise secondary particles formed by the aggregation of primary particles containing the lithium transition metal oxide. The average particle diameter D50 of the core component may be 1 μm to 20 μm. The primary particles may be composed of a single grain or a plurality of grains. The shape of the secondary particles may be spherical or oval.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a lithium secondary battery according to the present disclosure;

FIG. 2 shows a cathode active material 100 according to the present disclosure;

FIG. 3 shows a second group of candidates satisfying condition 1 in a first group of candidates;

FIG. 4 shows a second group of candidates satisfying condition 2 in the first group of candidates;

FIG. 5 shows an effective group in the second group of candidates, which has interfacial reaction energy of −0.05 eV or less for LiNi_{0.8}Co_{0.1}Mn_{0.1}O₂ and interfacial reaction energy of −0.15 eV or less for Li₆PS₅Cl;

FIG. 6A shows the formation energy of each composition when boron (B) of Li₃B₇O₁₂ in the effective group is substituted with aluminum (Al);

FIG. 6B shows the formation energy of each composition when boron (B) of LiB₃O₅ in the effective group is substituted with aluminum (Al);

FIG. 7 shows the formation energy of each composition when arsenic (As) in Li₃AsO₄ in the effective group is substituted with phosphorus (P);

FIG. 8A shows the formation energy of each composition when phosphorus (P) of Li₄P₂O₇ in the effective group is substituted with arsenic (As);

FIG. 8B shows the formation energy of each composition when phosphorus (P) of Li₄P₂O₇ in the effective group is substituted with vanadium (V);

FIG. 8C shows the formation energy of each composition when aluminum (Al) of LiAl₅O₈ in the effective group is substituted with boron (B);

FIG. 8D shows the formation energy of each composition when rhenium (Re) of LiReO₄ in the effective group is substituted with phosphorus (P); and

FIG. 8E shows the formation energy of each composition when rhenium (Re) of LiReO₄ in the effective group is substituted with vanadium (V).

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

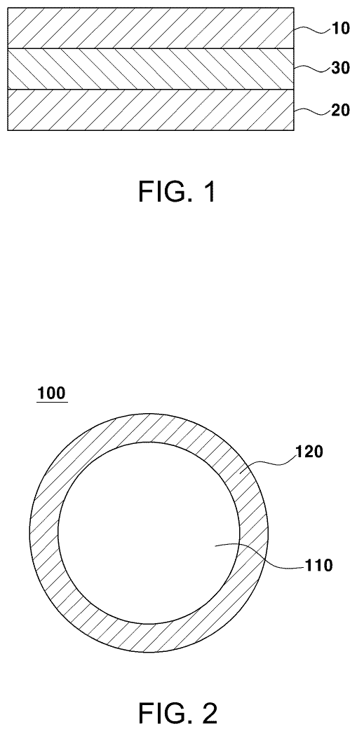

FIG. 1 shows a lithium secondary battery according to the present disclosure. The lithium secondary battery may include an all-solid-state battery. The lithium secondary battery may include a cathode 10, an anode 20, and a solid electrolyte layer 30 interposed between the cathode 10 and the anode 20.

The cathode 10 may include a cathode active material. FIG. 2 shows a cathode active material 100 according to the present disclosure. The cathode active material 100 may include a core component 110 and a coating part 120 applied onto the surface of the core component 110.

The core component 110 may include lithium transition metal oxide capable of intercalating and disintercalating lithium.

The lithium transition metal oxide may include any material that is common in the technical field to which the present disclosure belongs. An example of the lithium transition metal oxide may include LiNiₓ₁Coₓ₂Mnₓ₃O₂ (0.65≤x1≤0.85, 0.05<x2<0.25, 0.03<x3<0.2, and x1+x2+x3=1).

The core component 110 may be in the form of secondary particles in which primary particles containing the lithium transition metal oxide aggregate. Here, primary particles may indicate the smallest particle unit that may be distinguished as one lump when the cross-section of the core component 110 is observed using a device such as a scanning electron microscope (SEM). The primary particles may be composed of a single grain or a plurality of grains. Also, secondary particles may refer to an aggregate of primary particles. The shape of the secondary particles is not particularly limited and may be, for example, spherical or oval.

The average particle diameter D50 of the core component 110 is not particularly limited and may be, for example, 1 μm to 20 μm. The average particle diameter D50 of the core component 110 may be measured using a commercially available laser diffraction scattering-type particle size distribution analyzer, for example, a Microtrac particle size distribution analyzer. Alternatively, 200 particles may be randomly extracted from the electron micrograph and the average particle diameter thereof may be calculated.

The coating part 120 may prevent side reaction from occurring by blocking contact between the solid electrolyte and the core component 110 within the cathode 10.

The coating part 120 may include lithium oxide. The present disclosure is characterized by searching for lithium oxide with a novel composition that is electrochemically stable, has excellent interfacial stability with the core component 110 and the solid electrolyte, and does not cause side reaction, and by applying the same to the coating part 120. Below is a detailed description of the search process for lithium oxide with a new composition.

First, a population of lithium oxide may be prepared by performing data mining using the Crystallography Open Database (COD) and/or the Material Project (MP). Among numerous data on lithium oxide that may be mined using the COD and the MP, those that may be used as the coating part 120 must be found, but selection through actual tests is bound to take an astronomical amount of time and cost. Accordingly, the present disclosure proposes a method of searching for lithium oxide that is electrochemically stable and has excellent interfacial stability with other materials and is thus suitable for use as the coating part 120 without conducting actual tests.

A first group of candidates may be obtained by extracting the crystal structure of Li-M-O among data mined using the COD and/or the MP and removing the duplicate crystal structure from the result.

Next, a second group of candidates may be obtained by evaluating electrochemical stability of the first group of candidates. Specifically, in the first group of candidates, the second group of candidates satisfying condition 1 or condition 2 below may be selected.

[Condition 1] Reduction potential of the oxide is 2.5 V or less but greater than 0 V and oxidation potential of the oxide is 3.8 V to 5.5 V

[Condition 2] Electrochemical stability window (ESW) of the oxide is 2.5 V to 5.5 V.

The electrochemical stability window is the voltage range over which a material is neither oxidized nor reduced. The electrochemical stability window is the value obtained by subtracting the reduction potential from the oxidation potential and may be calculated as follows.

Specifically, in order to evaluate the phase equilibrium of a compound with a specific composition, a phase diagram may be constructed using the pymatgen package. The composition of the compound is referred to as composition C. The phase equilibrium of composition C corresponding to the minimum energy E_{eq}(C) may be determined by comparing the energy values of all relevant phases. The phase stability of composition C may be calculated using the decomposition energy (ΔE_{D}) for phase equilibrium.

$$△ {E}_{D} ( phase ) = {E}_{eq} ( C ) - E ( phase )$$

A grand potential phase diagram may be constructed to evaluate the stability of a material in equilibrium with the external environment. The grand potential phase diagram makes it possible to determine the phase equilibrium (C_{eq}(C, μ_{Li})) of a specific phase of composition C that is in equilibrium with the chemical potential of lithium (μ_{Li}). The specific phase of composition C is stable within the chemical potential of lithium. In the range outside the chemical potential of lithium, the composition of phase equilibrium (C_{eq}(C, μ_{Li})) may have different numbers of lithium elements. The number of lithium elements may vary depending on Δn_{Li}. The decomposition reaction energy at the chemical potential of lithium may be calculated using the following equation.

$$△ {E}_{{D}^{open}} ( phase , {μ}_{Li} ) = {E}_{eq} ( {C}_{eq} ( C , {μ}_{Li} ) ) - E ( phase ) - △ {n}_{Li} \cdot {μ}_{Li}$$

The electrode potential (Φ) may be treated as part of the chemical potential of lithium (μ_{Li}).

$${μ}_{Li} ( Φ ) = {μ}_{Li}^{0} - e Φ$$

Here, μ_{Li}⁰ may be the chemical potential of lithium metal. The electrochemical stability window may be estimated to be in the range of the electrode potential (Φ). The decomposition reaction energy at the applied electrode potential (Φ) may be calculated using the following equation.

$$△ {E}_{{D}^{open}} ( phase , Φ ) = △ {E}_{{D}^{open}} ( phase , {μ}_{Li} ( Φ ) )$$

More specifically, a method of measuring the electrochemical stability window described in J. Mater. Chem. A, 2016, 4, 3253-3266 may be utilized.

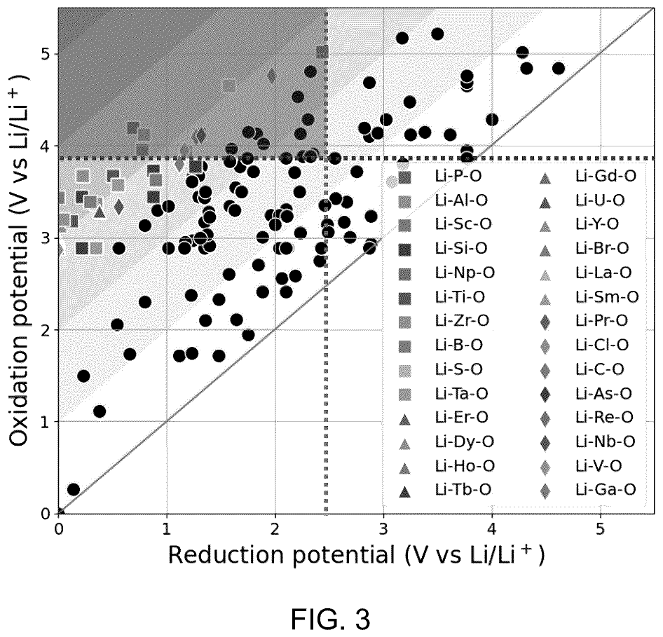

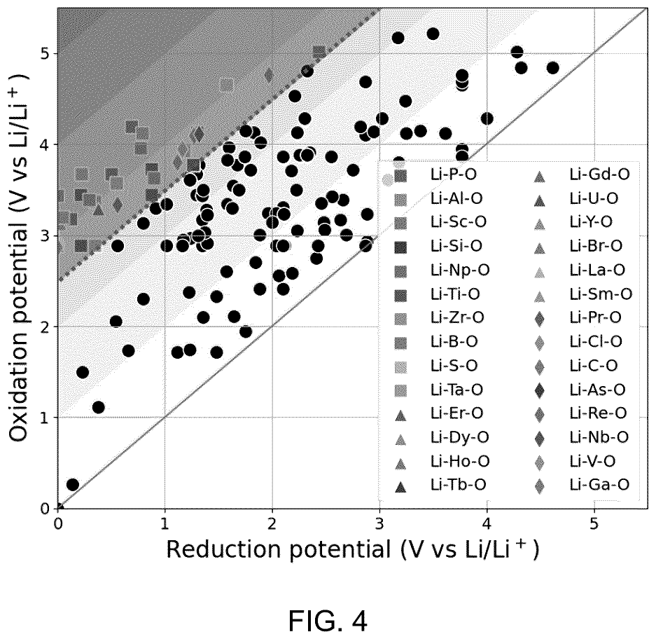

FIG. 3 shows the second group of candidates satisfying condition 1 in the first group of candidates. FIG. 4 shows the second group of candidates satisfying condition 2 in the first group of candidates.

Next, an effective group may be obtained by evaluating the interfacial stability of the second group of candidates. Specifically, when the interfacial reaction energy of the second group of candidates and LiNi_{0.8}Co_{0.1}Mn_{0.1}O₂ or the interfacial reaction energy of the second group of candidates and Li₆PS₅Cl is equal to or less than a predetermined value, an effective group may be selected. Specifically, in the second group of candidates, compounds having interfacial reaction energy of −0.05 eV or less for LiNi_{0.8}Co_{0.1}Mn_{0.1}O₂ and interfacial reaction energy of −0.2 eV or less for Li₆PS₅Cl may be selected as an effective group. Here, interfacial reaction energy may be calculated as follows.

The interface between compound A and compound B may be treated as a pseudo-binary system.

$${C}_{interface} ( {C}_{A} , {C}_{B} , x ) = x \cdot {C}_{A} + ( 1 - x ) \cdot {C}_{B}$$

C_{A} is the composition of compound A, C_{B} is the composition of compound B, and x is the mole fraction of compound A, which is 0 to 1.

The energy of the interface may be set as an energy linear combination of compound A and compound B.

$${E}_{interface} ( A , B , x ) = x \cdot E ( A ) + ( 1 - x ) \cdot E ( B )$$

The decomposition energy of the interface may be calculated using the following equation.

$$△ {E}_{D} ( A , B , x ) = {E}_{eq} ( {C}_{interface} ( {C}_{A} , {C}_{B} , x ) ) - {E}_{interface} ( A , B , x )$$

The reaction energy (ΔE_{D,mutual}) in the phase equilibrium of compound A and compound B may be calculated as follows.

$$△ {E}_{D , mutual} ( A , B , x ) = △ {E}_{D} ( A , B , x ) - x \cdot △ {E}_{D} ( A ) - ( 1 - x ) \cdot △ {E}_{D} ( B )$$

More specifically, a method of measuring the interfacial reaction energy described in J. Mater. Chem. A, 2016, 4, 3253-3266 may be utilized.

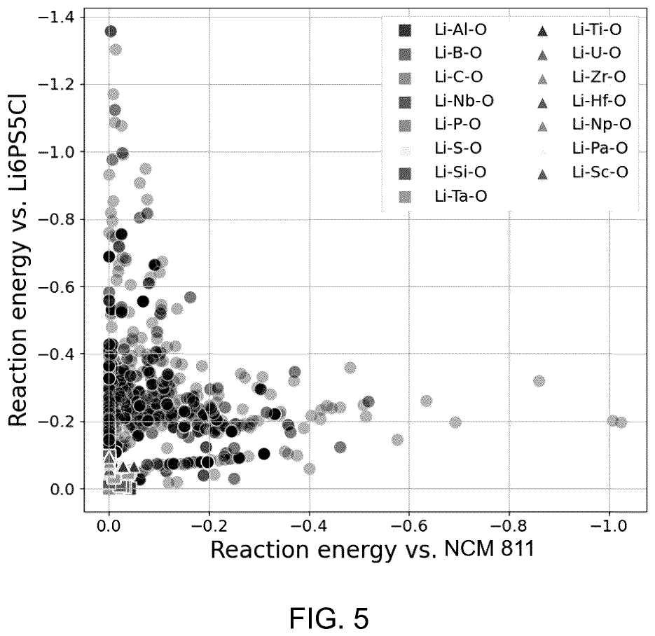

FIG. 5 shows the effective group in the second group of candidates, which has interfacial reaction energy of −0.05 eV or less for LiNi_{0.8}Co_{0.1}Mn_{0.1}O₂ and interfacial reaction energy of −0.15 eV or less for Li₆PS₅Cl.

The effective group may include compounds represented by Li-M-O. Here, M may be the first element. In the present disclosure, lithium oxide with a new composition having excellent electrochemical stability and interfacial stability by substituting at least a part of the first element with a second element having the same oxidation number or coordination number as the first element may be searched for and may be applied to the coating part 120. The possibility of substitution with the second element may be evaluated by calculating the formation energy of lithium oxide with the new composition.

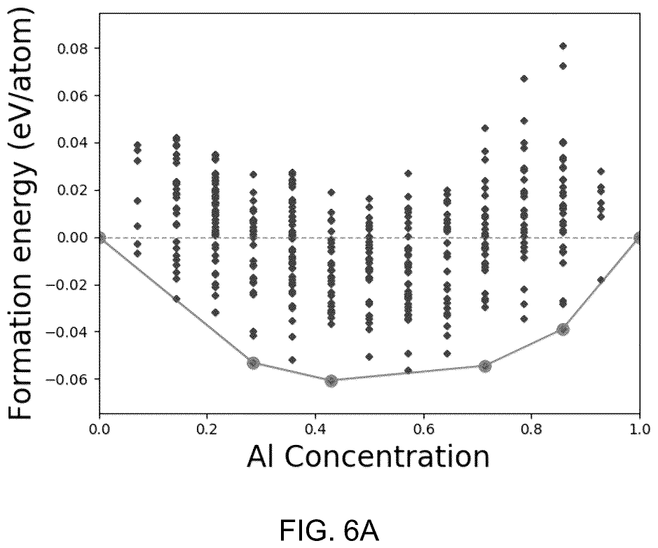

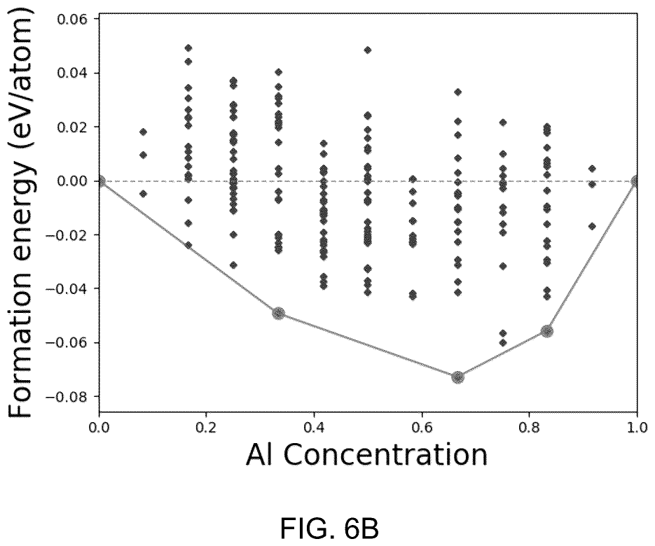

FIG. 6A shows the formation energy of each composition when boron (B) of Li₃B₇O₁₂ in the effective group is substituted with aluminum (Al). FIG. 6B shows the formation energy of each composition when boron (B) of LiB₃O₅ in the effective group is substituted with aluminum (Al). When the formation energy of a specific composition is a negative value, it may be determined that there is a possibility of substitution.

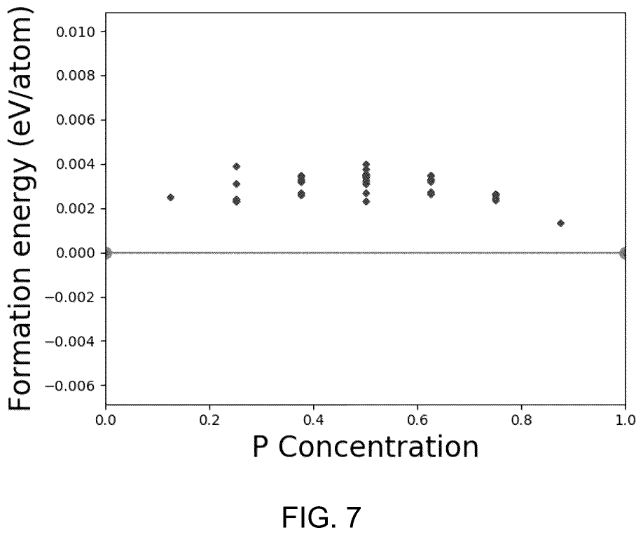

FIG. 7 shows the formation energy of each composition when arsenic (As) of Li₃AsO₄ in the effective group is substituted with phosphorus (P). Referring thereto, since the formation energy of all compositions is 0 eV/atom, Li₃AsO₄ cannot be substituted with phosphorus (P).

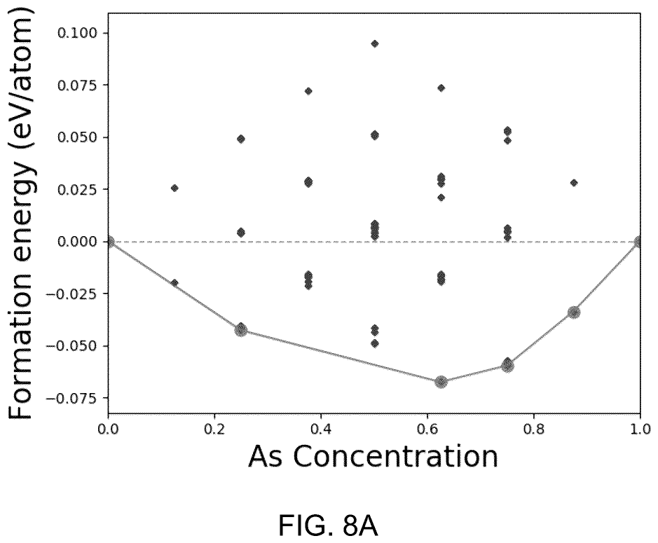

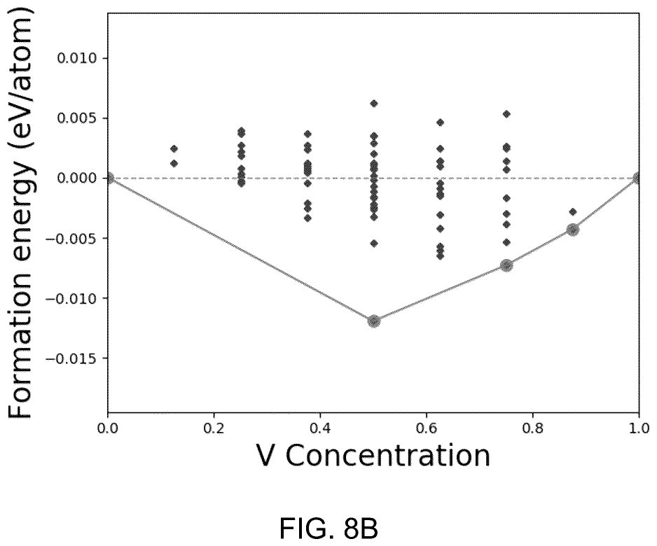

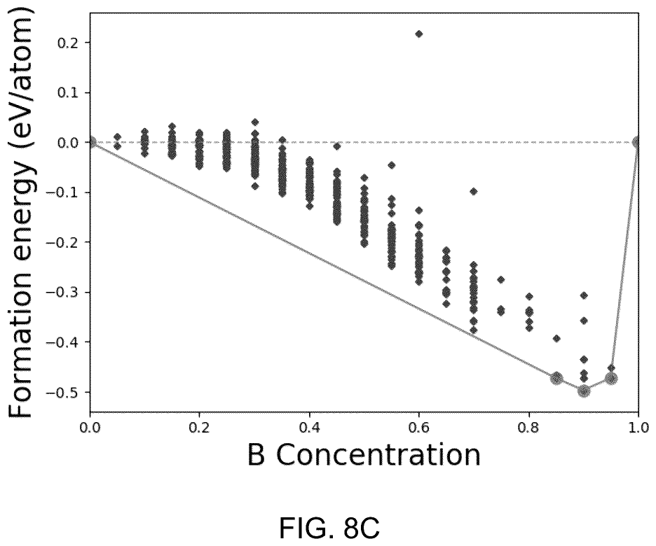

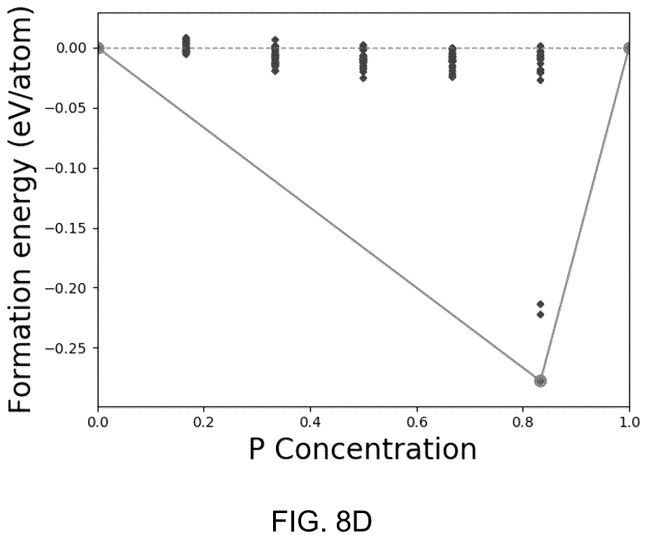

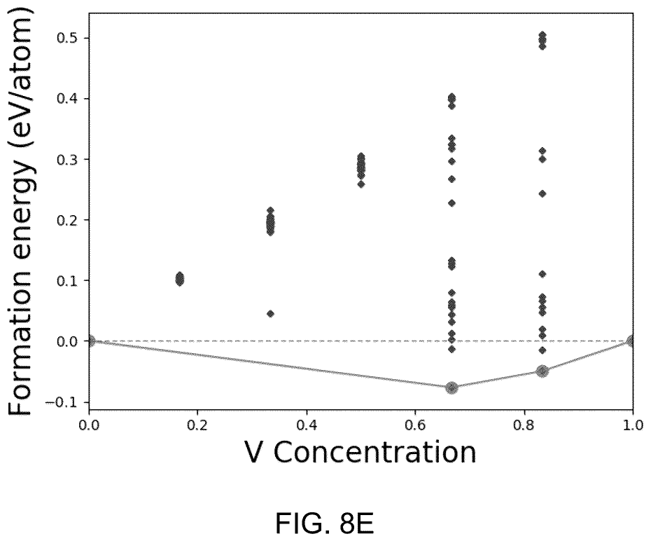

FIG. 8A shows the formation energy of each composition when phosphorus (P) of Li₄P₂O₇ in the effective group is substituted with arsenic (As). FIG. 8B shows the formation energy of each composition when phosphorus (P) of Li₄P₂O₇ in the effective group is substituted with vanadium (V). FIG. 8C shows the formation energy of each composition when aluminum (Al) of LiAl₅O₈ in the effective group is substituted with boron (B). FIG. 8D shows the formation energy of each composition when rhenium (Re) of LiReO₄ in the effective group is substituted with phosphorus (P). FIG. 8E shows the formation energy of each composition when rhenium (Re) of LiReO₄ in the effective group is substituted with vanadium (V).

The lithium oxide according to the present disclosure may be ultimately selected by evaluating the electrochemical stability and interfacial stability of each compound with a composition having a possibility of substitution in the same manner as described above. The results thereof are shown in Tables 1 and 2 below.

TABLE 1

| | | | | | Applica- |
|---|---|---|---|---|---|
| | | Electrochemical stability [V] | | | bility |
| | | Reduction | Oxidation | | to coating |
| Composition | x | potential | potential | ESW¹⁾ | part |
| Li₃B₇₋ₓAlₓO₁₂ | 0.2857 | 1.30 | 3.67 | 2.37 | ∘ |
| | 0.4286 | 1.30 | 3.67 | 2.37 | ∘ |
| | 0.7143 | 1.30 | 3.67 | 2.37 | ∘ |
| | 0.8571 | 1.29 | 3.67 | 2.38 | ∘ |
| LiAl₅₋ₓBₓO₈ | 0.85 | 1.96 | 4.25 | 2.29 | ∘ |
| | 0.9 | 2.18 | 4.45 | 2.27 | ∘ |
| | 0.95 | 2.18 | 4.45 | 2.27 | ∘ |
| Li₃B₃₋ₓAlₓO₅ | 0.3333 | 1.30 | 3.67 | 2.37 | ∘ |
| | 0.6667 | 1.30 | 3.67 | 2.37 | ∘ |
| | 0.8333 | 1.30 | 3.67 | 2.37 | ∘ |
| LiGa₅₋ₓAlₓO₈ | 0.6 | 1.89 | 4.02 | 2.13 | ∘ |
| LiAl₅₋ₓBₓO₈ | 0.85 | 1.96 | 4.25 | 2.29 | ∘ |
| | 0.90 | 2.18 | 4.45 | 2.27 | ∘ |
| | 0.95 | 2.18 | 4.45 | 2.27 | ∘ |
| LiRe₁₋ₓPₓO₄ | 0.8333 | 0.00 | 0.00 | 0.00 | x |
| LiRe₁₋ₓVₓO₄ | 0.6667 | 4.12 | 4.76 | 0.64 | x |
| | 0.8333 | 4.12 | 4.76 | 0.64 | x |
| Li₂Mo₁₋ₓNpₓO₄ | 0.6667 | 0.00 | 0.00 | 0.00 | x |
| Li₂Mo₁₋ₓWₓO₄ | 0.1667 | 2.30 | 3.86 | 1.56 | ∘ |
| Li₂W₁₋ₓTaₓO4 | 0.5 | 3.77 | 3.86 | 0.09 | x |
| Li₃Nb₇₋ₓTaₓO₁₉ | 0.0714 | 2.35 | 3.86 | 1.51 | ∘ |
| | 0.4286 | 2.49 | 3.93 | 1.44 | ∘ |
| Li₃Ta₇₋ₓNbₓO₁₉ | 0.8571 | 2.35 | 3.91 | 1.56 | ∘ |
| Li₄Np₁₋ₓNbₓO₅ | 0.25 | 0.00 | 0.00 | 0.00 | x |
| | 0.5 | 0.00 | 0.00 | 0.00 | x |
| | 0.75 | 0.00 | 0.00 | 0.00 | x |
| Li₄Np₁₋ₓPaₓO₅ | 0.5 | 0.00 | 0.00 | 0.00 | x |
| | 0.75 | 0.00 | 0.00 | 0.00 | x |
| Li₄Np₁₋ₓTaₓO₅ | 0.25 | 3.09 | 3.23 | 0.15 | x |
| | 0.5 | 3.09 | 3.23 | 0.15 | x |
| | 0.75 | 3.09 | 3.23 | 0.15 | x |
| LiNb₁₃₋ₓTaₓO₃₃ | 0.0769 | 2.49 | 3.93 | 1.44 | ∘ |
| | 0.1538 | 2.51 | 3.93 | 1.42 | ∘ |
| | 0.3077 | 2.54 | 3.96 | 1.42 | ∘ |
| | 0.3846 | 2.54 | 3.96 | 1.42 | ∘ |
| | 0.4615 | 2.54 | 3.96 | 1.42 | ∘ |
| | 0.5385 | 2.54 | 3.96 | 1.42 | ∘ |
| | 0.6154 | 2.54 | 3.96 | 1.42 | ∘ |
| | 0.6923 | 2.54 | 3.96 | 1.42 | ∘ |
| | 0.7692 | 2.54 | 3.96 | 1.42 | ∘ |
| | 0.8462 | 2.54 | 3.96 | 1.42 | ∘ |
| LiNb₃₋ₓTaₓO₈ | 0.3333 | 2.49 | 3.93 | 1.44 | ∘ |
| | 0.6667 | 2.51 | 3.93 | 1.42 | ∘ |
| | 0.8333 | 2.51 | 3.93 | 1.42 | ∘ |
| LiPa₁₋ₓNbₓO₃ | 0.25 | 2.61 | 3.86 | 1.25 | ∘ |
| LiPa₁₋ₓTaₓO₃ | 0.25 | 2.54 | 3.93 | 1.39 | ∘ |
| LiTa₃₋ₓNbₓO₈ | 0.1667 | 2.51 | 3.93 | 1.42 | ∘ |
| | 0.8333 | 2.49 | 3.91 | 1.42 | ∘ |

¹⁾Electrochemical stability window

TABLE 2

| | | | | Applica- |
|---|---|---|---|---|
| | | | | bility |
| | | Interfacial reaction energy [eV] | | to coating |
| Composition | x | NCM811¹⁾ | LPSCl²⁾ | part |
| Li₃B₇₋ₓAlₓO₁₂ | 0.2857 | −0.022 | −0.082 | ∘ |
| | 0.4286 | −0.025 | −0.082 | ∘ |
| | 0.7143 | −0.028 | −0.082 | ∘ |
| | 0.8571 | −0.028 | −0.082 | ∘ |
| LiAl₅₋ₓBₓO₈ | 0.85 | −0.042 | −0.082 | ∘ |
| | 0.9 | −0.044 | −0.082 | ∘ |
| | 0.95 | −0.044 | −0.082 | ∘ |
| Li₃B₃₋ₓAlₓO₅ | 0.3333 | −0.046 | −0.082 | ∘ |
| | 0.6667 | −0.043 | −0.082 | ∘ |
| | 0.8333 | −0.035 | −0.082 | ∘ |
| LiGa₅₋ₓAlₓO₈ | 0.6 | −0.026 | −0.082 | ∘ |
| LiAl₅₋ₓBₓO₈ | 0.85 | −0.034 | −0.082 | ∘ |
| | 0.90 | −0.050 | −0.187 | ∘ |
| | 0.95 | −0.042 | −0.082 | ∘ |
| LiRe₁₋ₓPₓO₄ | 0.8333 | −0.043 | −0.082 | ∘ |
| LiRe₁₋ₓVₓO₄ | 0.6667 | −0.035 | −0.275 | x |
| | 0.8333 | −0.184 | −0.623 | x |
| Li₂Mo₁₋ₓNpₓO₄ | 0.6667 | −0.068 | −0.588 | x |
| Li₂Mo₁₋ₓWₓO₄ | 0.1667 | −0.076 | −0.692 | x |
| Li₂W₁₋ₓTaₓO4 | 0.5 | −0.054 | −0.368 | x |
| Li₃Nb₇₋ₓTaₓO₁₉ | 0.0714 | −0.000 | −0.295 | x |
| | 0.4286 | −0.009 | −0.351 | x |
| Li₃Ta₇₋ₓNbₓO₁₉ | 0.8571 | −0.028 | −0.178 | ∘ |
| Li₄Np₁₋ₓNbₓO₅ | 0.25 | −0.005 | −0.151 | ∘ |
| | 0.5 | −0.010 | −0.173 | ∘ |
| | 0.75 | −0.013 | −0.196 | ∘ |
| Li₄Np₁₋ₓPaₓO₅ | 0.5 | −0.010 | −0.192 | ∘ |
| | 0.75 | −0.013 | −0.236 | x |
| Li₄Np₁₋ₓTaₓO₅ | 0.25 | −0.005 | −0.142 | ∘ |
| | 0.5 | −0.010 | −0.154 | ∘ |
| | 0.75 | −0.013 | −0.170 | ∘ |
| LiNb₁₃₋ₓTaₓO₃₃ | 0.0769 | −0.035 | −0.275 | x |
| | 0.1538 | −0.050 | −0.187 | ∘ |
| | 0.3077 | −0.041 | −0.193 | ∘ |
| | 0.3846 | −0.042 | −0.190 | ∘ |
| | 0.4615 | −0.043 | −0.181 | ∘ |
| | 0.5385 | −0.044 | −0.176 | ∘ |
| | 0.6154 | −0.045 | −0.169 | ∘ |
| | 0.6923 | −0.046 | −0.160 | ∘ |
| | 0.7692 | −0.047 | −0.150 | ∘ |
| | 0.8462 | −0.048 | −0.140 | ∘ |
| LiNb₃₋ₓTaₓO₈ | 0.3333 | −0.048 | −0.133 | ∘ |
| | 0.6667 | −0.049 | −0.126 | ∘ |
| | 0.8333 | −0.033 | −0.165 | ∘ |
| LiPa₁₋ₓNbₓO₃ | 0.25 | −0.035 | −0.132 | ∘ |
| LiPa₁₋ₓTaₓO₃ | 0.25 | −0.037 | −0.118 | ∘ |
| LiTa₃₋ₓNbₓO₈ | 0.1667 | −0.007 | −0.144 | ∘ |
| | 0.8333 | −0.005 | −0.116 | ∘ |

¹⁾Interfacial reaction energy of a compound with the corresponding composition and LiNi_{0.8}Co_{0.1}Mn_{0.1}O₂
²⁾Interfacial reaction energy of a compound with the corresponding composition and Li₆PS₅Cl

The compounds judged to be suitable for use in the coating layer in both Tables 1 and 2 may be applied to the coating part 120 according to the present disclosure.

The coating part 120 may include at least one lithium oxide selected from among Chemical Formula 1 to Chemical Formula 11 below.

Li₃B₇₋ₓ₁Alₓ₁O₁₂ [Chemical Formula 1]

Chemical Formula 1 may satisfy 0.2857≤x1≤0.8571.

LiAl₅₋ₓ₂Bₓ₂O₈ [Chemical Formula 2]

Chemical Formula 2 may satisfy 0.85≤x2≤0.95.

Li₃B₃₋ₓ₃Alₓ₃O₅ [Chemical Formula 3]

Chemical Formula 3 may satisfy 0.3333≤x3≤0.8333.

LiGa₅₋ₓ₄Alₓ₄O₈ [Chemical Formula 4]

In Chemical Formula 4, x4 may be 0.6.

LiAl₅₋ₓ₅Bₓ₅O₈ [Chemical Formula 5]

Chemical Formula 5 may satisfy 0.85≤x5≤0.95.

LiNb₁₃₋ₓ₆ Taₓ₆O₃₃ [Chemical Formula 6]

Chemical Formula 6 may satisfy 0.1538≤x6≤0.8462.

LiNb₃₋ₓ₇Taₓ₇O₈ [Chemical Formula 7]

Chemical Formula 7 may satisfy 0.3333≤x7≤0.8333.

LiPa₁₋ₓ₈Nbₓ₈O₃ [Chemical Formula 8]

In Chemical Formula 8, x8 may be 0.25.

LiPa₁₋ₓ₉Taₓ₉O₃ [Chemical Formula 9]

In Chemical Formula 9, x9 may be 0.25.

Li₃Ta₇₋ₓ₁₀Nbₓ₁₀O₁₉ [Chemical Formula 10]

In Chemical Formula 10, x10 may be 0.8571.

LiTa₃₋ₓ₁₁Nbₓ₁₁O₈ [Chemical Formula 11]
Chemical Formula 11 may satisfy 0.1667≤x11≤0.8333.

The lithium oxide may include lithium, a first element, and a second element that substitutes for at least a part of the first element.

When the first element forms an oxide with lithium, condition 1 or condition 2 below may be satisfied.

[Condition 1] Reduction potential of the oxide is 2.5 V or less but greater than 0 V and oxidation potential of the oxide is 3.8 V to 5.5 V

[Condition 2] Electrochemical stability window (ESW) of the oxide is 2.5 V to 5.5 V

Specifically, the first element may include boron (B), aluminum (Al), gallium (Ga), niobium (Nb), protactinium (Pa), or tantalum (Ta).

The second element may have the same oxidation number or coordination number as the first element.

Specifically, the second element may be different from the first element, and the second element may include aluminum (Al), boron (B), tantalum (Ta), or niobium (Nb).

The lithium oxide may have interfacial reaction energy of −0.05 eV or less for LiNi_{0.8}Co_{0.1}Mn_{0.1}O₂ and interfacial reaction energy of −0.2 eV or less for Li₆PS₅Cl.

The cathode 10 may further include a solid electrolyte, a conductive material, and a binder.

The solid electrolyte may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (in which Ha includes Cl, Br, or I and y satisfies 0<y≤2), Li_{7-z}PS_{6-z}(Ha1_{1-b}Ha2_{b})_{z} (in which Ha1 and Ha2 are different from each other, each independently includes Cl, Br or I, and b and z satisfy 0<b<1 and 0<z≤2), and combinations thereof.

Examples of the conductive material may include carbon black, conductive graphite, ethylene black, graphene, carbon nanotubes, carbon nanofiber, vapor grown carbon fiber, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder may exist in a granular or linear form in the cathode 10.

The cathode 10 may include 70 wt % to 90 wt % of the cathode active material, 10 wt % to 15 wt % of the solid electrolyte, 1 wt % to 5 wt % of the conductive material, and 1 wt % to 5 wt % of the binder. Here, the amount of each component may be appropriately adjusted in consideration of desired capacity and efficiency of the all-solid-state battery.

The thickness of the cathode 10 is not particularly limited, but may be 1 μm to 100 μm. The thickness of the cathode 10 may indicate an average value when a measurement target is measured at 5 points. Also, the thickness of the cathode 10 may indicate a thickness upon discharging of the lithium secondary battery.

According to the present disclosure, a cathode active material for a lithium secondary battery with excellent electrochemical stability can be obtained.

According to the present disclosure, a cathode active material for a lithium secondary battery with excellent interfacial stability with a solid electrolyte can be obtained.

The effects of the present disclosure are not limited to the above-mentioned effects. It should be understood that the effects of the present disclosure include all effects that can be inferred from the description of the present disclosure.

As the examples of the present disclosure have been described in detail above, the scope of the present disclosure is not limited to the aforementioned examples and various modifications and improvements made by those skilled in the art using the basic concept of the present disclosure defined in the following claims are also within the scope of the present disclosure.

What is claimed is:

1. A cathode active material for a lithium secondary battery, comprising:
a core component; and
a coating part applied onto a surface of the core component,
wherein the coating part comprises lithium oxide, and
wherein the lithium oxide comprises lithium, a first element, and a second element that substitutes for at least a part of the first element.

2. The cathode active material of claim 1, wherein, when the first element forms an oxide with the lithium,
reduction potential of the oxide is about 2.5 V or less but greater than 0 V and oxidation potential of the oxide is about 3.8 V to 5.5 V; or
electrochemical stability window (ESW) of the oxide is about 2.5 V to 5.5 V

3. The cathode active material of claim 1, wherein the first element comprises boron (B), aluminum (Al), gallium (Ga), niobium (Nb), protactinium (Pa), or tantalum (Ta).

4. The cathode active material of claim 1, wherein an oxidation number or coordination number of the second element is equal to an oxidation number or coordination number of the first element.

5. The cathode active material of claim 1, wherein the second element is different from the first element, and the second element comprises aluminum (Al), boron (B), tantalum (Ta), or niobium (Nb).

6. The cathode active material of claim 1, wherein the lithium oxide has interfacial reaction energy of about −0.05 eV or less for LiNi_{0.8}CO_{0.1}Mn_{0.1}O₂.

7. The cathode active material of claim 1, wherein the lithium oxide has interfacial reaction energy of about −0.2 eV or less for Li₆PS₅Cl.

8. The cathode active material of claim 1, wherein the lithium oxide comprises at least one selected from among Chemical Formula 1 to Chemical Formula 11 below:
Li₃B₇₋ₓ₁Alₓ₁O₁₂ [Chemical Formula 1]
Chemical Formula 1 satisfies 0.2857≤x1≤0.8571;
LiAl₅₋ₓ₂Bₓ₂O₈ [Chemical Formula 2]
Chemical Formula 2 satisfies 0.85≤x2≤0.95;
Li₃B₃₋ₓ₃Alₓ₃O₅ [Chemical Formula 3]
Chemical Formula 3 satisfies 0.3333≤x3≤0.8333;
LiGa₅₋ₓ₄Alₓ₄O₈ [Chemical Formula 4]
In Chemical Formula 4, x4 is 0.6;
LiAl₅₋ₓ₅Bₓ₅O₈ [Chemical Formula 5]
Chemical Formula 5 satisfies 0.85≤x5≤0.95;
LiNb₁₃₋ₓ₆Taₓ₆O₃₃ [Chemical Formula 6]
Chemical Formula 6 satisfies 0.1538≤x6≤0.8462;
LiNb₃₋ₓ₇Taₓ₇O₈ [Chemical Formula 7]
Chemical Formula 7 satisfies 0.3333≤x7≤0.8333;
LiPa₁₋ₓ₈Nbₓ₈O₃ [Chemical Formula 8]
In Chemical Formula 8, x8 is 0.25;
LiPa₁₋ₓ₉Taₓ₉O₃ [Chemical Formula 9]
In Chemical Formula 9, x9 is 0.25;
Li₃Ta₇₋ₓ₁₀Nbₓ₁₀O₁₉ [Chemical Formula 10]
In Chemical Formula 10, x10 is 0.8571; and
LiTa₃₋ₓ₁₁Nbₓ₁₁O₈ [Chemical Formula 11]
Chemical Formula 11 satisfies 0.1667≤x11≤0.8333.

9. A cathode for a lithium secondary battery, comprising:
the cathode active material of claim 1; and
a solid electrolyte.

10. A lithium secondary battery comprising:
a cathode comprising a cathode active material comprising a core component and a coating part applied onto a surface of the core component, wherein the coating part comprises lithium oxide, and wherein the lithium oxide comprises lithium, a first element, and a second element that substitutes for at least a part of the first element;
an anode; and
a solid electrolyte layer interposed between the cathode and the anode.

11. The lithium secondary battery of claim 10, wherein the first element in the lithium oxide comprises boron (B), aluminum (Al), gallium (Ga), niobium (Nb), protactinium (Pa), or tantalum (Ta).

12. The lithium secondary battery of claim 10, wherein the second element in the lithium oxide comprises aluminum (Al), boron (B), tantalum (Ta), or niobium (Nb).

13. The lithium secondary battery of claim 10, wherein the solid electrolyte layer comprises a sulfide-based solid electrolyte having an argyrodite crystal structure.

14. The lithium secondary battery of claim 10, wherein the cathode further comprises a conductive material selected from the group consisting of carbon black, conductive graphite, ethylene black, graphene, carbon nanotubes, carbon nanofiber, and vapor grown carbon fiber.

15. The lithium secondary battery of claim 10, wherein the lithium oxide in the coating part has interfacial reaction energy of about −0.05 eV or less for LiNi_{0.8}Co_{0.1}Mn_{0.1}O₂ and about −0.2 eV or less for Li₆PS₅Cl.

16. A lithium secondary battery comprising:
a cathode comprising a cathode active material comprising a core component and a coating part applied onto a surface of the core component, wherein the coating part comprises lithium oxide, wherein the lithium oxide comprises lithium, a first element, and a second element that substitutes for at least a part of the first element, and wherein the core component comprises lithium transition metal oxide;
an anode; and
a solid electrolyte layer interposed between the cathode and the anode.

17. The lithium secondary battery of claim 16, wherein the core component comprises secondary particles formed by the aggregation of primary particles containing the lithium transition metal oxide.

18. The lithium secondary battery of claim 16, wherein the average particle diameter D50 of the core component is about 1 μm to 20 μm.

19. The lithium secondary battery of claim 16, wherein the primary particles are composed of a single grain or a plurality of grains.

20. The lithium secondary battery of claim 16, wherein the shape of the secondary particles is spherical or oval.
